(19) United States
(12) Patent Application Publication
(10) Pub. No.: US 2025/0020522 A1
(43) Pub. Date: Jan. 16, 2025

(54) Electronic Devices With Temperature Sensors

(71) Applicant: Apple Inc., Cupertino, CA (US)

(72) Inventors: John P Bergen, San Jose, CA (US); Vincenzo Costanza, San Diego, CA (US)

(21) Appl. No.: 18/628,146

(22) Filed: Apr. 5, 2024

Related U.S. Application Data
(60) Provisional application No. 63/512,829, filed on Jul. 10, 2023.

(51) Int. Cl. G01K 17/00; G01K 1/02; G01K 1/08

(52) U.S. Cl. CPC G01K 17/00; G01K 1/026; G01K 1/08

(57) ABSTRACT

An electronic device may include a housing and an ambient temperature sensor in the housing. The ambient temperature sensor may include a temperature sensor, a heat flux sensor, and a heat source. The heat source may heat the heat flux sensor, and an ambient temperature may be determined based on measurements from the temperature sensor and the heat flux sensor. If additional temperature sensors and/or heat flux sensors are included in the ambient temperature sensor, the ambient temperature may be determined directly based on heat flux and temperature differences between the sensors. Alternatively, the heat flux sensor may measure a rise in heat flux, and control circuitry may fit a convection coefficient to the rise in the heat flux. The ambient temperature may then be determined based on the convection coefficient. Instead of heating the heat flux sensor, the heat flux sensor may be cooled to determine the ambient temperature.

This application claims the benefit of U.S. provisional patent application No. 63/512,829, filed Jul. 10, 2023, which is hereby incorporated by reference herein in its entirety.

### FIELD

This relates generally to electronic devices, and, more particularly, to electronic devices with temperature sensors.

### BACKGROUND

Electronic devices such as laptop computers, cellular telephone, and other equipment are sometimes provided with environmental sensors, such as ambient light sensors, image sensors, and microphones.

### SUMMARY

An electronic device, such as a wristwatch device or other wearable electronic device, may include a housing and a display in the housing. The electronic device may also include an ambient temperature sensor in the housing.

The ambient temperature sensor may include a temperature sensor, a heat flux sensor, and a heat source. The heat source may heat the heat flux sensor, and an ambient temperature may be determined based on measurements from the temperature sensor and the heat flux sensor.

If additional temperature sensors and/or heat flux sensors are included in the ambient temperature sensor, the ambient temperature may be determined directly based on the heat flux measured by the heat flux sensors and temperature differences between the sensors.

Alternatively, the heat flux sensor may measure a rise in the heat flux, and control circuitry may fit a convection coefficient to the rise in the heat flux. In particular, a convection coefficient calibration curve may be used to fit the convection coefficient to the rise in heat flux. The ambient temperature may then be determined based on the convection coefficient.

Instead of heating the heat flux sensor, the heat flux sensor may be cooled, such as by using a Peltier device, to determine the ambient temperature. In particular, the heat flux sensor may be cooled to have zero heat flux, and the temperature to which it is cooled will be equal to the ambient temperature.

### BRIEF DESCRIPTION OF THE DRAWINGS

FIG. 1 is a drawing of an illustrative wearable electronic device in accordance with some embodiments.

FIG. 2 is a diagram of an illustrative electronic device in accordance with some embodiments.

FIG. 3 is a side view of an illustrative device with an ambient temperature sensor in accordance with some embodiments.

FIG. 4 is a top view of an illustrative ambient temperature sensor that includes multiple heat flux sensors and/or temperature sensors in accordance with some embodiments.

FIG. 5 is a flowchart of illustrative steps that may be used to determine an ambient temperature by heating a heat flux sensor in accordance with some embodiments.

FIG. 6 is a graph of an illustrative rise in heat flux in accordance with some embodiments.

FIG. 7 is a graph of an illustrative convection coefficient calibration curve in accordance with some embodiments.

FIG. 8 is a flowchart of illustrative steps that may be used to determine an ambient temperature by cooling a heat flux sensor in accordance with some embodiments.

### DETAILED DESCRIPTION

Electronic devices are often carried by users as they conduct their daily activities. For example, a user may carry an electronic device on their person throughout the day while walking, commuting, working, exercising, etc. In some situations, it may be desirable for the user to know the ambient temperature in the device's environment. For example, ambient temperature may be used in combination with fitness applications (e.g., when calculating a user's power output at different ambient temperatures), weather sensing and/or forecasting, and/or or other desired functions.

To make ambient temperature measurements, the electronic device may include an ambient temperature sensor that includes four temperature sensors, or two heat flux sensors and two temperature sensors. The temperature sensors and/or the heat flux sensors may be exposed to the same ambient temperature, but may heated/cooled to different temperatures. For example, a heater may be provided to change the temperature of one or multiple of the temperature sensors and/or heat flux sensors. These sensors may have the same or related resistance, and the ambient temperature may be calculated based on the measurements from the sensors. Alternatively, a rise in heat flux of the heated temperature sensor(s) may be measured, and a convection coefficient may be determined from a calibration curve. Based on the heat flux, the convection coefficient, and the temperature of another temperature sensor, the ambient temperature may be determined.

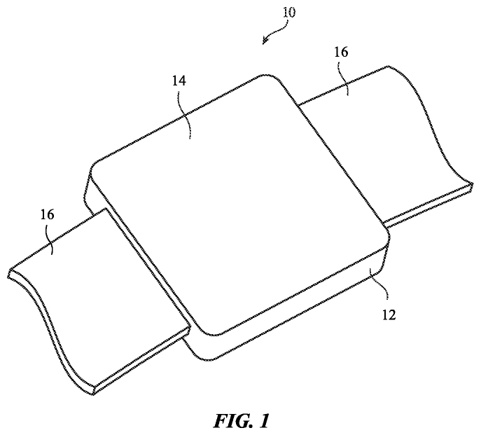

In general, any suitable electronic devices may include an ambient temperature sensor. As shown in FIG. 1, a wearable electronic device 10, which may be a wristwatch device, may have a housing 12, a display 14, and a strap 16. In particular, display 14 may be on a front face of wearable device 10. The wristwatch may attach to a user's wrist via strap 16. When worn on the user's wrist, a rear face of wearable device 10 (i.e., a rear surface of housing 12) may contact or be oriented toward the user's wrist. In some embodiments, device 10 may include various sensors that are in contact with the user's wrist, and the sensors may gather health or activity data (e.g., heart rate data or blood oxygen data) from the user.

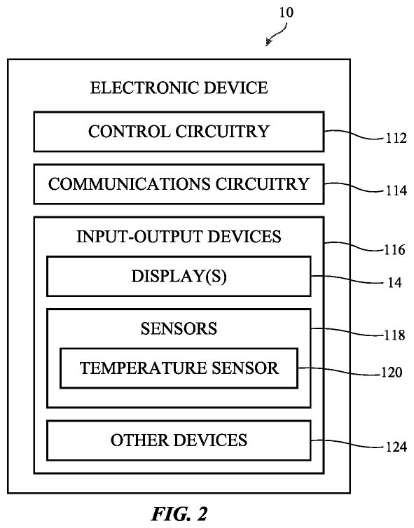

Although FIG. 1 shows electronic device 10 shown as a wristwatch device, this is merely illustrative. In general, electronic device 10 may be any desired device, such as a media player, or other handheld or portable electronic device, a cellular telephone device (e.g., a smartphone), a wristband device, a pendant device, a headphone, a speaker, a smart speaker, an ear bud or earpiece device, a head-mounted device such as glasses, goggles, a helmet, or other equipment worn on a user's head, or other wearable or miniature device, a navigation device, or other accessory, and/or equipment that implements the functionality of two or more of these devices. Illustrative configurations in which electronic device 10 is a portable electronic device such as a cellular telephone, head-mounted device, ear bud, wristwatch, or portable computer may sometimes be described herein as examples. Regardless of the form factor of device 10, an illustrative schematic diagram of device 10 is shown in FIG. 2.

As shown in FIG. 2, electronic devices such as electronic device 10 may have control circuitry 112. Control circuitry 112 may include storage and processing circuitry for controlling the operation of device 10. Circuitry 112 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 112 may be based on one or more microprocessors, microcontrollers, digital signal processors, baseband processors, power management units, audio chips, graphics processing units, application specific integrated circuits, and other integrated circuits. Software code may be stored on storage in circuitry 112 and run on processing circuitry in circuitry 112 to implement control operations for device 10 (e.g., data gathering operations, operations involving the adjustment of the components of device 10 using control signals, etc.).

Electronic device 10 may include communications circuitry 114, which may include wired and/or wireless communications circuitry. For example, electronic device 10 may include radio-frequency transceiver circuitry, such as cellular telephone transceiver circuitry, wireless local area network transceiver circuitry (e.g., WiFi® circuitry), short-range radio-frequency transceiver circuitry that communicates over short distances using ultra high frequency radio waves (e.g., Bluetooth® circuitry operating at 2.4 GHz or other short-range transceiver circuitry), millimeter wave transceiver circuitry, and/or other wireless communications circuitry.

Device 10 may include input-output devices 116. Input-output devices 116 may be used to allow a user to provide device 10 with user input. Input-output devices 116 may also be used to gather information on the environment in which device 10 is operating. Output components in devices 116 may allow device 10 to provide a user with output and may be used to communicate with external electrical equipment.

Input-output devices 116 may include one or more optional displays such as displays 14. Displays 14 may be organic light-emitting diode displays or other displays with light-emitting diodes, liquid crystal displays, microLED displays, or other displays. Displays 14 may be touch sensitive (e.g., displays 14 may include two-dimensional touch sensors for capturing touch input from a user) and/or displays 14 may be insensitive to touch.

Input-output devices 116 may include sensors 118. Sensors 118 may include, for example, temperature sensors (e.g., thermistors or thermocouples), three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors (e.g., a magnetometer), audio sensors (microphones), ambient light sensors, microphones for gathering voice commands and other audio input, sensors that are configured to gather information on motion, position, and/or orientation (e.g., accelerometers, gyroscopes, pressure sensors, compasses, and/or inertial measurement units that include all of these sensors or a subset of one or two of these sensors), health sensors that measure various biometric information (e.g., heartrate sensors, such as a photoplethysmography sensor), electrocardiogram sensors, and perspiration sensors) and/or other sensors.

Sensors 118 may also include one or more temperature sensor(s) 120. Temperature sensor(s) 120 may be incorporated into device 10, and may measure an ambient temperature by heating one or more heat flux sensors or temperature sensors in ambient temperature sensor 120, and determining the ambient temperature based on at least a measured heat flux and a measured temperature. Temperature sensor(s) 120 may also be referred to as ambient temperature sensors, environmental temperature sensors, and/or external temperature sensors herein.

If desired, input-output devices 116 may include other devices 124 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components.

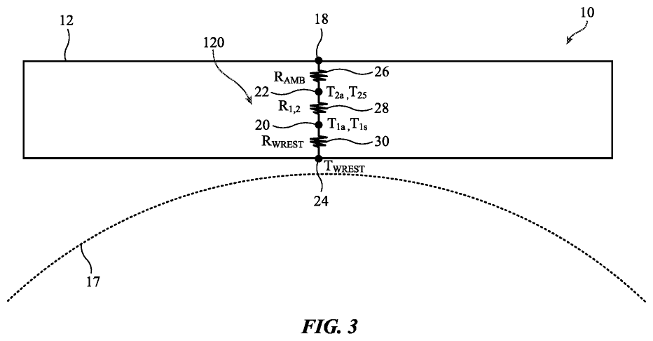

An illustrative example of a device having an ambient temperature sensor is shown in FIG. 3. As shown in FIG. 3, device 10 may include ambient temperature sensor 120 in housing 12. Ambient temperature sensor 120 may include temperature sensors T₁ₐ and T_{1b} 20, and temperature sensors T₂ₐ and T_{2b} 22. Temperature sensors 20 and 22 may be thermocouples or thermistors, as examples.

A known thermal resistance R_{1,2} 28 may be present between temperature sensors 20 and 22. Thermal resistance 28 may be present in the circuitry between temperature sensors 20 and 22, and/or may be provided by components or structures between temperature sensors 20 and 22.

It may be desirable to determine the ambient temperature T_{ambient} 18 based on the measurements of temperature sensors 20 and 22. In particular, T_{ambient} 18 may be determined using Equation 1,

$${T}_{ambient} = {T}_{1} + \frac{{R}_{a m b}}{{R}_{1 - 2}} ( {T}_{1} - {T}_{2} ) \qquad ( 1 )$$

where T₁ and T₂ correspond to the temperature at sensors 20 and 22, respectively, and R₁₋₂ is a thermal resistance difference between temperature sensors 20 and 22. However, T_{ambient} and R_{amb}, which corresponds to the thermal resistance of the ambient, are both unknowns. Therefore, R_{amb} should be determined.

Although Equation 1 describes determining ambient temperature 18 using sensors 20 and 22, this is merely illustrative. In some embodiments, sensors 20 and 22 may be used to determine external/environmental temperature T_{wrist} 24 of the user's wrist 17. When measuring temperature 24, thermal resistance R_{wrist} 30 will also be an unknown that can be determined.

Regardless of the external/environmental temperature that temperature sensors 20 and 22 are used to measure, the thermal resistance (e.g., thermal resistance R_{amb} or R_{wrist}) may be determined by measuring the air speed of particles in the air outside of device 10. To measure the air speed of the particles, a doppler particle detection device may be used. In particular, the doppler particle detection device may emit a laser or other light (e.g., infrared light) into the ambient air, and the emitted light may be scattered by particles in the air. By measuring the scattered light (e.g., scattered light that is reflected back to device 10), the speed of the particles and therefore the air speed may be determined, and the thermal resistance (e.g., thermal resistance R_{amb} or R_{wrist}) may be calculated. Therefore, given Equation 1, the ambient temperature may be determined.

Alternatively, the thermal resistance (e.g., thermal resistance R_{amb} or R_{wrist}) may be determined by measuring the heat flux at sensors 20 and 22. For example, the heat flux may be determined using four temperature sensors.

In the illustrative example of FIG. 3, temperature sensors 20 may include temperature sensor T₁ₐ and temperature sensor T_{1b}, while temperature sensors 22 may include temperature sensor T₂ₐ and temperature sensor T_{2b}. By including four temperature sensors, a heat flux between two sets of temperature sensors may be determined. In particular, a first heat flux may be determined between temperature sensor T₁ₐ and temperature sensor T₂ₐ, and a second heat flux may be determined between temperature sensor T_{1b} and temperature sensor T_{2b}. The equations to determine the first and second heat fluxes may be given by Equations 2 and 3, respectively,

$${Q}_{a} = \frac{{T}_{1 a} - {T}_{2 a}}{{R}_{1 a - 2 a}} \qquad ( 2 )$$

$${Q}_{b} = \frac{{T}_{1 b} - {T}_{2 b}}{{R}_{1 b - 2 b}} \qquad ( 3 )$$

where Qₐ is the heat flux between temperature sensors T₁ₐ and T₂ₐ, Q_{b} is the heat flux between temperature sensors T_{1b} and T_{2b}, each T corresponds to the temperature at each respective temperature sensor, and each R corresponds to the thermal resistance between the temperature sensors. In this way, a heat flux between the temperature sensors may be determined using the temperatures at each temperature sensor and the resistance between the temperature sensors. In other words, temperature sensors 20 and/or temperature sensors 22 may form heat flux sensors that can determine the heat flux between the temperature sensors.

Once the heat fluxes have been determined using Equations 2 and 3, ambient resistance 26 may be calculated using Equation 4,

$${R}_{a m b} = \frac{{T}_{1 a} - {T}_{1 b}}{{Q}_{a} + {Q}_{b}} \qquad ( 4 )$$

and ambient temperature 18 may be calculated using Equation 5,

$${T}_{ambient} = {T}_{1 b} + {Q}_{b} {R}_{a m b} \qquad ( 5 )$$

using the heat fluxes and ambient thermal resistance determined in Equations 2-4.

By using four temperature sensors, two heat fluxes may be calculated, allowing both ambient resistance 26 and ambient temperature 18 to be determined. In this way, an ambient temperature may be measured using temperature sensors 20 and 22.

In an illustrative embodiment, temperature sensor T₁ₐ may be a first temperature sensor, temperature sensor T₂ₐ may be a second temperature sensor, temperature sensor T_{1b} may be a third temperature sensor, and T_{2b} may be a fourth temperature sensor. The heat flux may be determined between the temperature sensors using Equations 2 and 3, and the ambient temperature may then be calculated using Equations 4 and 5.

Although Equations 2-5 describe determining ambient temperature 18 using sensors 20 and 22, this is merely illustrative. In some embodiments, sensors 20 and 22 may be used to determine external/environmental temperature T_{wrist} 24 of the user's wrist 17. In this scenario, resistance R_{wrist} 30 will also be an unknown that is determined using heat fluxes Qₐ and Q_{b}. In general, any environmental temperature may be determined using sensors 20 and 22. As used herein, an environmental temperature may refer to any temperature external to an electronic device, such as an ambient temperature or a temperature of an object external to the electronic device.

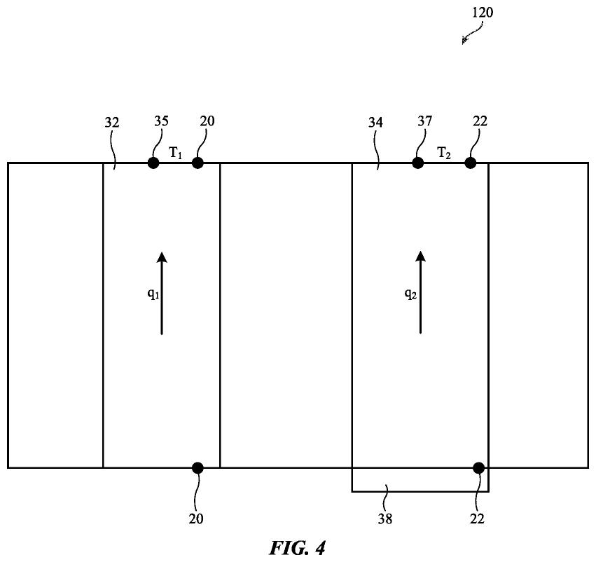

In general, to determine an environmental temperature using Equations 1-5, the temperature sensors must be at different temperatures. In other words, one heat flux must be different from the other heat flux (e.g., the heat fluxes given by Equations 2 and 3). To create a temperature difference between the temperature sensors, a heater may be used. An illustrative example of an environmental temperature sensor with a heater is shown in FIG. 4.

As shown in FIG. 4, ambient temperature sensor 120 may include heater 38. Heater 38 may be used to heat temperature sensors 20, while temperature sensors 22 may be unheated. In this way, heater 38 may change the heat flux through temperature sensors 22 relative to the heat flux through temperature sensors 20. The ambient temperature may then be determined using temperature sensors 20 and 22 according to Equations 1-5.

As an alternative to using four temperature sensors 20 and 22, heat flux sensors may be used in combination with two temperature sensors. In particular, as shown in FIG. 4, heat flux sensors 32 and 34 may be used in temperature sensor 120. Heat flux sensors 32 and 34 may measure heat fluxes q₁ and q₂ (which may correspond to heat fluxes Qₐ and Q_{b} that may be calculated using Equations 2 and 3, respectively) directly. Heat flux sensors 32 and 34 may be, for example, transducers that generate signals that are proportional to the heat incident on sensors 32 and 34.

Heater 38 may apply heat to heat flux sensor 34, while heat flux sensor 32 may remain unheated. In other words, heater 38 may heat sensor 34 more than it heats sensor 32. In this way, heater 38 may create a difference between heat fluxes q₁ and q₂.

If heat flux sensors 32 and 34 are used, temperature sensors 20 and 22 may be omitted. Instead, temperature sensor T₁ 35 and temperature sensor T₂ 37 may be used in combination with heat flux sensors 32 and 34 to determine the ambient temperature (e.g., temperature 18 in FIG. 3). First, a heat transfer coefficient of convection h may be calculated using Equation 6,

$$h = \frac{{q}_{1} - {q}_{2}}{{T}_{1} - {T}_{2}} \qquad ( 6 )$$

where T is the temperature at each of temperature sensors 35 and 37. The ambient temperature may be calculated using Equation 7,

$${T}_{a mbient} = {T}_{1} - \frac{{q}_{1}}{h} \qquad ( 7 )$$

using the heat transfer coefficient h from Equation 6 and the temperature and heat flux measured by temperature sensor 35 and heat flux sensor 32, respectively.

In an illustrative embodiment, heat flux sensor 32 may be a first heat flux sensor (or a first sensor), temperature sensor 35 may be a first temperature sensor (or a second sensor), heat flux sensor 34 may be a second heat flux sensor (or a third sensor), and temperature sensor 37 may be a second temperature sensor (or a fourth sensor). The ambient temperature may be determined using the measurements from the first and second heat flux sensors and the first and second temperature sensors (or the first, second, third, and fourth sensors).

In this way, the ambient temperature may be determined using two heat flux sensors (32 and 34) that measure heat fluxes across temperature sensor 120 and two temperature sensors (35 and 37) that measure temperatures at each of heat flux sensors 32 and 34.

Although heater 38 has been described as being a standalone heating component that is used to heat sensor 34, this is merely illustrative. If desired, any component in device 10 that emits heat, such as a display, a battery, or other circuitry, may be used as heater 38 to heat sensor 34 (or to heat temperature sensors 20 if used in lieu of sensor 34).

Equations 6 and 7 are simplified by accounting for convection heating without accounting for radiation. However, this is merely illustrative. In some embodiments, both convection and radiation may be considered. In particular, a similar heat balance may be used to calculate ambient temperature and to account for radiation using two heat flux sensors 32 and 34 and two temperature sensors 35 and 37.

As an alternative to determining ambient temperature using two heat fluxes, as described above in connection with FIGS. 3 and 4, a single heat flux sensor and a temperature sensor, or two temperature sensors, may be used to determine the environmental temperature. In an illustrative embodiment, temperature sensor 35 of FIG. 4 may be a first temperature sensor, and temperature sensors 22 may be second and third temperature sensors. The heat flux may be determined between the second and third temperature sensors 22. The heat flux and the temperature at the first temperature sensor may be used to determine the environmental temperature. In another illustrative embodiment, temperature sensor 35 of FIG. 4 and heat flux sensor 34 may be used to determine the environmental temperature. However, these embodiments are merely illustrative. In general, any suitable combination of temperature sensors and/or heat flux sensors in FIG. 4 may be used to determine the environmental temperature.

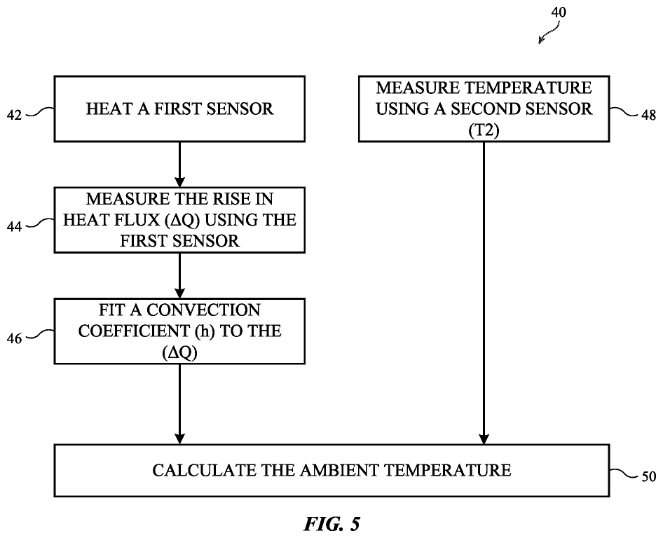

An illustrative example of steps that may be used to determine the environmental temperature using a single heat flux sensor and a temperature sensor, or two temperature sensors, is shown in FIG. 5.

As shown in FIG. 5, flowchart 40 may include, at step 42, a first sensor may be heated. In particular, a heater, such as heater 38 of FIG. 4, may be used to heat the first sensor. The first sensor may be a temperature sensor (e.g., temperature sensor 35), such as a thermistor or thermocouple, as examples. Alternatively, the first sensor may be a heat flux sensor, and the heat flux sensor may correspond to heat flux sensor 34 of FIG. 4, for example.

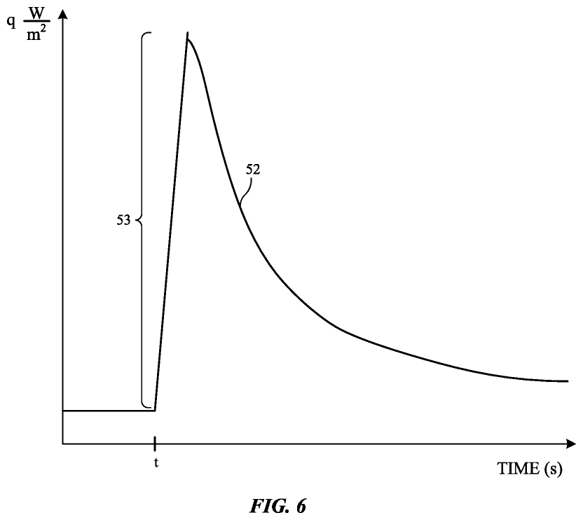

At step 44, the first sensor may measure a rise in heat flux (ΔQ) due to the heat from the heater. If the first sensor is a temperature sensor, the rise in heat flux may be determined based on the change in temperate (T₁) at the temperature sensor (e.g., temperature sensor(s) 22 of FIG. 4—which may be second and third temperature sensors used with first temperature sensor 35, as an example), a known thermal resistance of the temperature sensor, and/or an amount of heat applied by the heater. Alternatively, if the first sensor is a heat flux sensor, the rise in heat flux may be measured directly. An illustrative example of a heat flux measurement is shown in FIG. 6.

As shown in FIG. 6, curve 52 is an illustrative relationship of heat flux q (W/m²) over time (s). Curve 52 may have a sharp rise in heat flux 53 at time t, which may correspond to the time at which the heater applies heat to the heat flux sensor. The rise in heat flux 53 is equal to AQ.

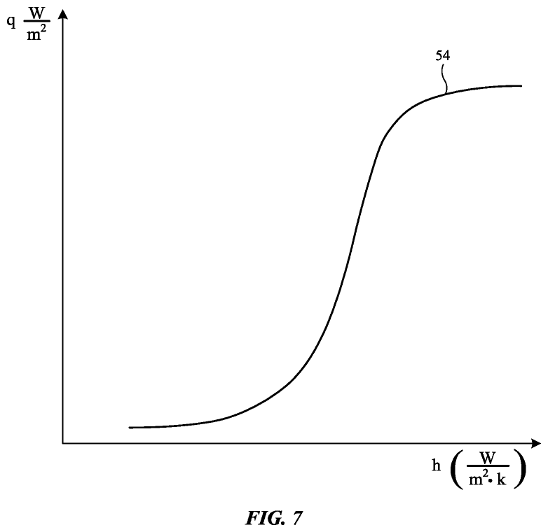

Returning to FIG. 5, at step 46, a convection coefficient h may be fit to the measured ΔQ. In particular, a calibration curve for the convection coefficient h may be used to determine the convection coefficient h based on the rise in heat flux ΔQ. An illustrative example of a convection coefficient h calibration curve is shown in FIG. 7.

As shown in FIG. 7, illustrative calibration curve 54 may give a relationship between the heat flux q (W/m²) and the convection coefficient h (W/m²·K). The illustrative relationship given by calibration curve 54 may correspond to the geometry of device 10, and may be generated under different convection conditions, such as measuring the response of the ambient temperature sensor (e.g., the heat flux sensor or temperature sensor in the ambient temperature sensor) when a fan is on, when the device is subject to external heat, such as ambient heat, or in other suitable convection conditions.

By generating convection coefficient calibration curve 54, the curve may be used to fit a convection coefficient h to heat flux curve 52 of FIG. 6. For example, a convection coefficient curve may be fit to the rise in heat flux ΔQ of FIG. 6 to have the same rise in heat flux, giving a convection coefficient h. Alternatively, since calibration curve 54 gives a direct relationship between convection coefficient h and heat flux q, calibration curve 54 may be used to determine convection coefficient h from the corresponding measured heat flux in FIG. 6. In this way, the convection coefficient h may be determined from the rise in heat flux ΔQ 53 (FIG. 6) and the convection coefficient calibration curve 54 (FIG. 7).

Returning to FIG. 5, in addition to measuring the heat flux, at step 48, a second sensor may be used to measure a temperature (T₂). The second sensor may be a temperature sensor, such as a thermocouple or thermistor, as examples.

At step 50, the ambient temperature may be calculated. In particular, because the heat flux Q, convection coefficient h, and temperature T₂ have been determined, the ambient temperature may be determined using Equation 7 (substituting T₂ for T₁). In this way, the ambient temperature may be determined using two sensors.

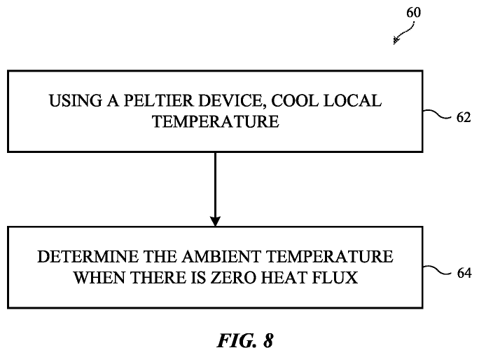

Although the examples of FIGS. 3-7 have described determining the ambient temperature by heating a temperature sensor or a heat flux sensor, these examples are merely illustrative. In some embodiments, the ambient temperature may be determined by cooling a temperature sensor or heat flux sensor. An illustrative flowchart of steps that may be used to determine the ambient temperature by cooling a sensor is shown in FIG. 8.

As shown in FIG. 8, illustrative flowchart 60 may include, at step 62, cooling the local temperature of a device, such as the local location of a sensor in device 10, using a Peltier device. For example, the same arrangement shown in FIG. 4 may be used, except that a Peltier device may be used instead of heater 38 to cool a heat flux sensor (or temperature sensor).

At step 64, the ambient temperature may be determined when there is zero heat flux (e.g., when the temperature of the heat flux sensor is equal to the ambient temperature). In other words, when it is determined that the heat flux is zero, either from a zero heat flux sensor measurement or an equal temperature sensor measurement on either side of a material with known thermal resistance (see FIG. 4), the ambient temperature may be known.

In particular, as shown in Equation 4, R_{amb} may be zero when the heat flux across a heat flux sensor is zero (e.g., the temperature on either side of the heat flux sensor is the same). Therefore, using Equation 1, the ambient temperature, T_{ambient}, may be equal to the temperature at the heat flux sensor, T₁, when R_{amb} is zero. In this way, the ambient temperature may be determined by cooling a heat flux sensor.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is illustrative and various modifications can be made to the described embodiments. The foregoing embodiments may be implemented individually or in any combination.

What is claimed is:

1. An electronic device, comprising:
a housing; and
an ambient temperature sensor in the housing, wherein the ambient temperature sensor comprises:
a temperature sensor,
a heat flux sensor, and
a heat source, wherein the heat source is configured to heat the heat flux sensor, and the ambient temperature sensor is configured to determine an ambient temperature based on measurements from the temperature sensor and the heat flux sensor.

2. The electronic device of claim 1, wherein the temperature sensor is a first temperature sensor, and the heat flux sensor comprises second and third temperature sensors.

3. The electronic device of claim 2, wherein the heat flux sensor is configured to make a heat flux measurement based on temperature measurements from the second and third temperature sensors, and wherein the ambient temperature sensor is configured to determine the ambient temperature based on the heat flux measurement and the measurement from the first temperature sensor.

4. The electronic device of claim 2, wherein the ambient temperature sensor further comprises:
a fourth temperature sensor, wherein the ambient temperature sensor is configured to determine the ambient temperature based on measurements from the first, second, third, and fourth temperature sensors.

5. The electronic device of claim 1, wherein the temperature sensor is a second temperature sensor, the heat flux sensor is a second heat flux sensor, and the ambient temperature sensor further comprises:
a first temperature sensor; and
a first heat flux sensor, wherein the ambient temperature sensor is configured to determine the ambient temperature based on measurements from the first and second temperature sensors and the first and second heat flux sensors.

6. The electronic device of claim 5, wherein the heat source is configured to heat the second heat flux sensor more than the first heat flux sensor.

7. The electronic device of claim 1, further comprising:
control circuitry configured to determine the ambient temperature based on a rise in heat flux measured by the heat flux sensor and a temperature measured by the temperature sensor.

8. The electronic device of claim 7, wherein the control circuitry is configured to determine the ambient temperature by fitting a convection coefficient to the measured rise in the heat flux.

9. A method of operating an electronic device having an ambient temperature sensor, the method comprising:
heating a first sensor in the ambient temperature sensor;
measuring a rise in heat flux using the first sensor;
measuring a temperature using a second sensor in the ambient temperature sensor; and
determining an ambient temperature based on the rise in the heat flux and the temperature.

10. The method of claim 9, wherein measuring the rise in the heat flux comprises measuring the rise in the heat flux using a heat flux sensor.

11. The method of claim 9, further comprising:
determining a convection coefficient based on the rise in the heat flux.

12. The method of claim 11, wherein determining the convection coefficient comprises fitting the convection coefficient to the rise in the heat flux based on a convection coefficient calibration curve.

13. The method of claim 9, further comprising:
measuring an additional heat flux using a third sensor; and
measuring an additional temperature using a fourth sensor, wherein determining the ambient temperature comprises determining the ambient temperature based on the rise in the heat flux, the temperature, the additional heat flux, and the additional temperature.

14. The method of claim 13, wherein determining the ambient temperature further comprises:
determining a convection coefficient based on the rise in the heat flux, the temperature, the additional heat flux, and the additional temperature; and
determining the ambient temperature based on the convection coefficient.

15. The method of claim 9, wherein measuring the rise in the heat flux comprises measuring a temperature difference using two temperature sensors.

16. A wearable electronic device, comprising:
a housing;
an environmental temperature sensor in the housing, wherein the environmental temperature sensor comprises a heat flux sensor;
a heater coupled to the environmental temperature sensor, wherein the heater is configured to heat the environmental temperature sensor; and
control circuitry configured to determine an environmental temperature based on a rise in heat flux measured by the heat flux sensor.

17. The wearable electronic device of claim 16, wherein the environmental temperature sensor further comprises:
a temperature sensor, wherein the control circuitry is configured to determine the environmental temperature based on the rise in the heat flux and a temperature measured by the temperature sensor.

18. The wearable electronic device of claim 17, wherein the control circuitry is configured to determine the environmental temperature by fitting a convection coefficient to the rise in the heat flux.

19. The wearable electronic device of claim 17, wherein the temperature sensor is a first temperature sensor, the heat flux sensor comprises second and third temperature sensors, and the environmental temperature sensor further comprises a fourth temperature sensor, wherein the environmental temperature sensor is configured to determine the environmental temperature based on measurements from the first, second, third, and fourth temperature sensors.

20. The wearable electronic device of claim 16, further comprising:
a strap that is configured to be coupled to the housing, wherein the housing is a wristwatch housing that is configured to contact a wrist.

21. The wearable electronic device of claim 20, wherein the environmental temperature comprises an ambient temperature.

22. The wearable electronic device of claim 20, wherein the environmental temperature comprises a temperature of the wrist.
